(19) United States
(12) Patent Application Publication
(10) Pub. No.: US 2002/0193226 A1
(43) Pub. Date: Dec. 19, 2002

(54) Method of manufacturing bags having closure strips and a cursor

(75) Inventor: Henri Georges Bois, Neuilly Sur Seine (FR)

Correspondence Address: Finnegan, Henderson, Farabow,, Garrett & Dunner, L.L.P., 1300 I Street, N.W., Washington, DC, 20005-3315, US

(73) Assignee: FLEXICO-FRANCE, Henonville (FR)

(21) Appl. No.: 10/164,561

(22) Filed: Jun. 10, 2002

(30) Foreign Application Priority Data
Jun. 11, 2001 (FR) 01 07616

(51) Int. Cl. B31B 1/82

(52) U.S. Cl. 493/394

(57) ABSTRACT

The present invention relates to a method of automatically manufacturing bags fitted with complementary closure strips associated with an actuating cursor, in which at least one film adapted to form the bag walls is fed continuously, closure assemblies comprising complementary closure strips associated with an actuating cursor are provided, and each closure assembly made in this way is fixed on the wall-forming film, wherein the closure assemblies are brought onto the film transversely to the travel direction of said film, and the length of each closure assembly is greater than the width of the bag, such that, while it is being brought into position, the actuating cursor is located in the vicinity of one end of the closure assembly beyond the edge of the film.

The present invention relates to the field of bags comprising complementary closure strips designed to enable users to open and close said bags on successive occasions.

To this end, numerous types of bags and/or closure strips have already been proposed.

### BACKGROUND OF THE INVENTION

By way of non-limiting example, reference can be made to documents U.S. Pat. Nos. 4,929,225, 4,892,414, EP-0 562 774, EP-0 395 362, U.S. Pat. Nos. 5,382,094, 3,181,583, and EP-0 728 665.

More precisely still, the present invention relates to the field of bags having closure strips that are opened and closed by a cursor.

Various type of bags and closure strips actuated by a cursor have also been proposed.

On this point, reference can be made to document FR-2 778 362, for example.

Compared with bags which do not have a cursor, bags including closure strips actuated by a cursor have the enormous advantage of being easy to handle.

The cursor disengages the strips in order to open the bags or engages the strips in order to close said bags. To do this, it suffices to displace the cursor in translation along the strips.

Attempts have certainly been made to make strips without cursors easier to handle, in particular by providing ribs on the walls of the bags thus fitted, thereby enabling the strips to be easily located by touch. However, such dispositions do not give full satisfaction compared with bags fitted with a cursor. Firstly, making such ribs complicates the production installation. Secondly, such ribs cannot be located and actuated as easily as a cursor.

Nevertheless, in practice, it has been observed that in the past bags fitted with closure strips actuated by a cursor have not been subject to major industrial development.

This seems due in particular to the fact that cursor-actuated closure strips are awkward to use on known automatic bag forming and/or filling machines. The cursors constitute extra thickness which makes both moving cursor-fitted strips and/or films, and forming the necessary heat seals very awkward to perform on automatic machines.

For this reason, and as described in documents EP-0051010, EP-0102301, and EP-0479661, proposals have been made to add cursors to the strips after the closure strips themselves have been fixed on the film(s) constituting a bag. Nevertheless, such dispositions generally require fairly complex equipment for feeding the cursors, opening them up, and then closing them on the closure strips, while ensuring that the cursors and the closure strips are accurately positioned, often while traveling continuously.

### OBJECTS AND SUMMARY OF THE INVENTION

An object of the invention is to provide novel means which present better performance than the prior art.

To this end, the invention proposes a method of automatically manufacturing bags fitted with complementary closure strips associated with an actuating cursor, in which:

at least one film adapted to form the bag walls is fed continuously;

closure assemblies comprising complementary closure strips associated with an actuating cursor are provided; and

each closure assembly made in this way is fixed on the wall-forming film; wherein:

the closure assemblies are brought onto the film transversely to the travel direction of said film; and

the length of each closure assembly is greater than the width of the bag, such that, while it is being brought into position, the actuating cursor is located in the vicinity of one end of the closure assembly beyond the edge of the film.

The present invention also relates to a machine for implementing the above-mentioned method.

The machine comprises:

means capable of continuously feeding at least one film adapted to form the bag walls;

means capable of providing closure assemblies comprising complementary closure strips associated with an actuating cursor; and

means capable of fixing each closure assembly made in this way on the wall-forming film; wherein:

the closure assemblies are brought onto the film transversely to the travel direction of said film; and

the length of each closure assembly is greater than the width of the bag, such that, while it is being brought into position, the actuating cursor is located in the vicinity of one end of the closure assembly beyond the edge of the film.

### BRIEF DESCRIPTION OF THE DRAWINGS

Other characteristics and advantages of the invention appear from the following description which is purely illustrative and non-limiting and which must be read with reference to the accompanying drawings, in which:

FIG. 1 is a diagram showing a preferred implementation of the present invention;

FIG. 2 is perspective view showing a cursor associated with a closure assembly;

FIG. 3 is longitudinal-section view of the cursor; and

FIGS. 4 and 5 are two cross-section views of the cursor on lines IV-IV and V-V of FIG. 2.

### MORE DETAILED DESCRIPTION

As mentioned above, the present invention relates to the manufacture, on an automatic machine, of reclosable bags having closure strips that are actuated by a cursor.

The present invention can be applied both to machines for automatically manufacturing bags that run horizontally, and to machines for automatically manufacturing bags that run vertically.

In addition, the present invention applies both to automatic bag-making machines, said bags are filled during a step subsequent to the manufacturing step and possibly at a geographical location that is different from the place of manufacture, and to forming, filling, and sealing (FFS) machines where all three operations are performed at a single location and during successive steps.

Thus, the present invention applies preferably and in non-limiting manner to automatic forming, filling, and sealing machines, and very advantageously to such machines that run vertically.

A description of such automatic FFS machines that run vertically can be found in the documents cited in the prior art of the present application.

Such machines are well known to the person skilled in the art and another complete description of said machines is not given below.

Nevertheless, it is recalled that such machines comprise a forming collar which receives, as input, a plane film coming from an unwinder, and which provides, as output, the film formed into a tube, a filling funnel which opens out into the forming collar and consequently into said tube, longitudinal hot-sealing means for sealing the tube longitudinally, and means capable of operating sequentially to generate a first transverse line of heat sealing before a product is inserted into the tube via the filling funnel, then a second transverse line of heat sealing once the product has been inserted into the tube, in order to seal a package about said product.

In the accompanying figures, the film constituting the bag walls, a closure assembly, and an associated actuating cursor are respectively referenced 100, 200, and 300.

As mentioned above, in the context of the present invention:

the film 100 adapted to form the bag walls travels in a direction D;

the closure assemblies 200 comprising complementary closure strips 210, 220, each associated with an actuating cursor 300, are provided on the film 100 in a direction T that is transverse to the travel direction D of the film; and

each closure assembly 200 made in this way is fixed on the wall-forming film 100.

The closure assemblies 200 are fed onto the film 100 at a pitch, measured along direction D, equal to the pitch of the bags, i.e. to the height of the bags, with said height being measured perpendicularly to the closure strips 200.

More precisely still, in the context of the present invention, the length of each closure assembly 200 is greater than the width of the bag, such that, while it is being brought into position, the actuating cursor 300 is located in the vicinity of one end of the closure assembly 200 beyond the edge of the film 100.

Thus, in the context of the present invention, the cursor 300 does not constitute extra thickness on the film 100 and does not prevent the bag from being sealed whether sealing is implemented in the form of lines of sealing extending transversely or longitudinally.

Naturally, once the bag is completed, the cursor 300 can be moved freely along the closure assembly 200 in order to fulfill its function.

Naturally, the closure strips 210, 220 can be the subject of numerous variant embodiments. Preferably, they are respectively a male strip and a female strip, or else they are complementary hooks. Their structure is not described in more detail below.

The closure strips 210, 220 are preferably carried by lateral support webs 212, 222 via which they are fixed to the film 100, e.g. by heat-sealing.

If necessary, the lateral webs 212, 222 can initially be connected together by a connection membrane 230 that is torn the first time the bag is opened. To this end, the connection membrane 230 can be provided with a line of weakness or perforations. Such a connection membrane 230 demonstrates whether or not the bag has already been opened.

In addition, the cursors 300 can be the subject of numerous variant embodiments. Each cursor 300 is preferably made of a soleplate 310 which carries, on one face, two lateral flanges 320, 322 and a central separating rib 330 which co-operates with the lateral flanges 320, 322, to define two passages 340, 342, which converge or diverge depending on the direction under consideration, and which are designed to receive respective ones of the strips 210, 220. The structure of cursors 300 suitable for being used in the context of the invention is not described in further detail below.

The film 100 used in the context of the present invention can be the subject of numerous variant embodiments. It can be simple film made of a single thermoplastic material, or indeed a composite thermoplastic material, or even a laminate made of plastic-coated paper or metallized film for example.

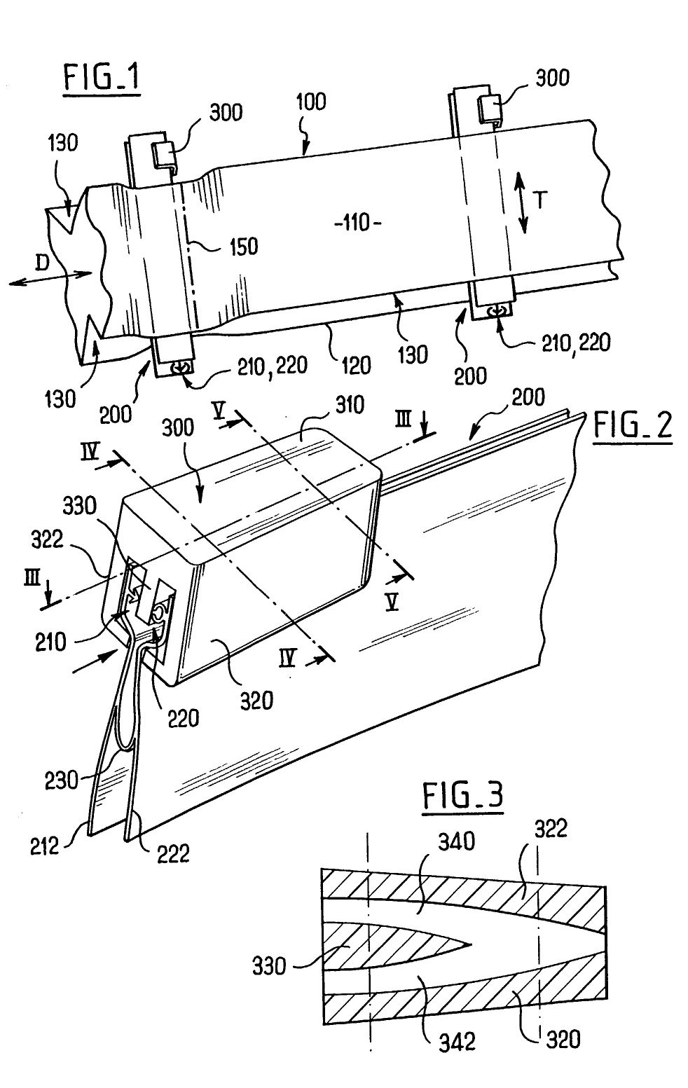

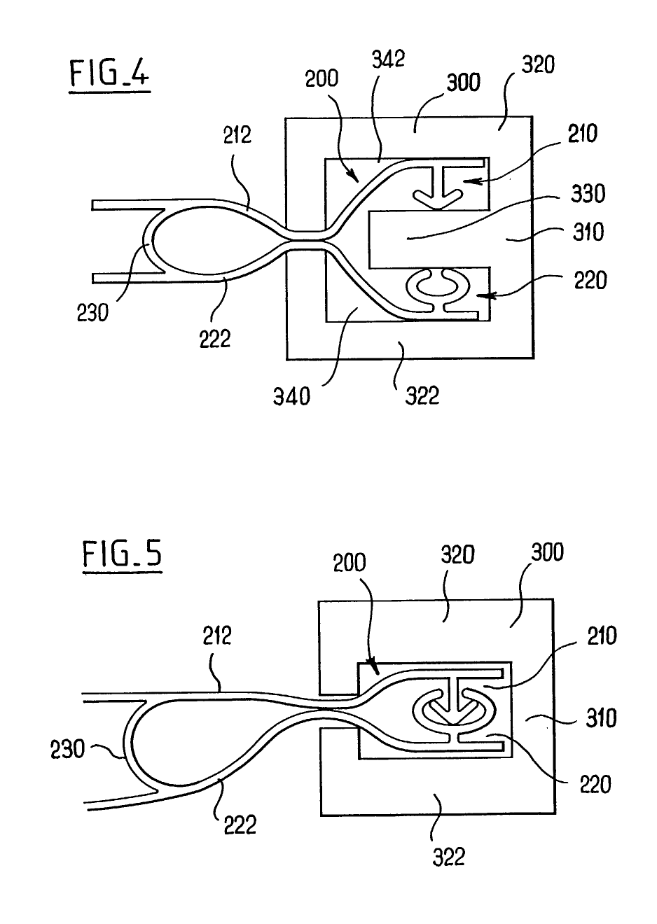

Accompanying FIG. 1 is a diagram of a preferred embodiment of the present invention in which the film 100 constituting the bags is made of two superposed sheets 110, 120.

Such sheets 110, 120 can be heat-sealed together directly, along their longitudinal edges.

However, in the preferred embodiment shown in accompanying FIG. 1, V-folded film segments 130 are fed between the longitudinal edges to form lateral bellows on the bags. The length of the segments 130 correspond to the length of the bags. The closure assemblies 200 are thus engaged between the ends of the segments 130.

In a variant, such lateral bellows can be obtained by folding the film 100 itself in the same way.

When the bags are made from a single film 100, said film is preferably provided sequentially with at least one lateral notch through which the closure assemblies 200 can be passed.

In addition, the lateral bellows need not be made as distinct V-folded film segments 130 which are attached separately, but can be made from a continuous strip of film folded in this way into a V-shape. The continuous strip is preferably provided sequentially with lateral notches through which the closure assemblies 200 can be passed.

The closure assemblies 200 are preferably heat-sealed onto the film 100 in such a manner as to ensure that the resulting bags are completely airtight.

FIG. 1 shows, on the lefthand side, a closure assembly 200 which has been fixed onto the film 100, while on the righthand side, it shows a closure assembly 200 prior to being fixed onto the film 100. In addition, FIG. 1 shows an optional transverse perforated line 150 in the film 100 in order to separate two adjacent bags. Naturally, the bottom of the bag adjacent to said perforated line 150 must be sealed, e.g. by heat-sealing, if the bag has already been filled.

Naturally, the present invention is not limited to the particular embodiments described above but extends to any variant within the ambit thereof.

1/ A method of automatically manufacturing bags fitted with complementary closure strips associated with an actuating cursor, in which:
at least one film adapted to form the bag walls is fed continuously;
closure assemblies comprising complementary closure strips associated with an actuating cursor are provided; and
each closure assembly made in this way is fixed on the wall-forming film; wherein:
the closure assemblies are brought onto the film transversely to the travel direction of said film; and
the length of each closure assembly is greater than the width of the bag, such that, while it is being brought into position, the actuating cursor is located in the vicinity of one end of the closure assembly beyond the edge of the film.

2/ A method according to claim 1, the method being implemented on a machine for automatically manufacturing bags that travel horizontally through the machine.

3/ A method according to claim 1, the method being implemented on a machine for automatically manufacturing bags that travel vertically through the machine.

4/ A method according to claim 1, the method being implemented on a machine for automatically manufacturing, filling, and sealing bags.

5/ A method according to claim 1, wherein the film constituting the bags is made of two superposed sheets.

6/ A method according to claim 5, wherein the sheets are heat-sealed together directly, along their longitudinal edges.

7/ A method according to claim 5, wherein V-folded film elements are fed between the longitudinal edges of the sheets to form lateral bellows on the bags.

8/ A method according to claim 7, wherein the V-folded film elements are made of segments having the length of the bags.

9/ A method according to claim 7, wherein the V-folded film elements are made of continuous strips provided sequentially with notches through with the closure assemblies can be passed.

10/ A method according to claim 1, wherein lateral bellows are obtained by folding the film onto itself.

11/ A method according to claim 1, wherein the film is provided sequentially with lateral notches through which the closure assemblies can be passed.

12/ A machine for automatically manufacturing bags fitted with complementary closure strips for implementing the method according to claim 1, the machine comprising:
means capable of continuously feeding at least one film adapted to form the bag walls;
means capable of providing closure assemblies comprising complementary closure strips associated with an actuating cursor; and
means capable of fixing each closure assembly made in this way on the wall-forming film; wherein:
the closure assemblies are brought onto the film transversely to the travel direction of said film; and
the length of each closure assembly is greater than the width of the bag, such that, while it is being brought into position, the actuating cursor is located in the vicinity of one end of the closure assembly beyond the edge of the film.

13/ A bag obtained by implementing the method according to claim 1 and/or from the machine according to claim 12, wherein the bag comprises a closure assembly of length greater than the width of the bag, such that the actuating cursor can be placed in the vicinity of one end of the closure assembly beyond the edge of the film.
